(19) United States
(12) Patent Application Publication
(10) Pub. No.: US 2009/0093903 A1
(43) Pub. Date: Apr. 9, 2009

(54) METHODS, SYSTEMS, AND COMPUTER PROGRAM PRODUCTS FOR AUTOMATING PROCESS AND EQUIPMENT QUALIFICATIONS IN A MANUFACTURING ENVIRONMENT

(75) Inventors: Bruce Clemens, Essex Junction, VT (US); Marco A. D'Antonio, Poughkeepsie, NY (US); John Federico, Poughkeepsie, NY (US); Glade S. Keaney, Red Hook, NY (US); Gregory L. MacDonald, Poughkeepsie, NY (US); Christopher P. Pluchino, Pine Bush, NY (US); Paloma Zapata, Barcelona (ES)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/867,162

(22) Filed: Oct. 4, 2007

(51) Int. Cl. G06F 19/00

(52) U.S. Cl. 700/109; 700/108

(57) ABSTRACT

Methods, systems, and computer program products for automating process and equipment qualifications in a manufacturing environment are provided. A method includes defining a triggering event for initiating a qualification of an equipment, process module, or process. The qualification is configured to identify whether the equipment, process module, or process is operating according to specified criteria. The method also includes qualifying a monitor for use in the qualification. Upon the occurrence of the triggering event, the method includes running qualified monitors through the qualification. Based upon the results of qualifying the monitor for use in the qualification or the results of the execution of the qualification, the method includes determining and implementing a disposition for the monitor.

### BACKGROUND OF THE INVENTION

The present disclosure relates generally to manufacturing execution systems and, in particular, to methods, systems, and computer program products for automating process and equipment qualifications in a manufacturing environment.

Computer information management (CIM) systems used in automated IC fabrication facilities (Fabs), such as a facility for processing 300 mm wafers, may include an automated manufacturing execution system (MES), an automated material handling system (AMHS), a material control system (MCS), and an automated real time dispatcher (RTD). In such automated facilities, the basic goals are generally the same: to operate the overall facility with very high degree of efficiency, quality and flexibility, in order to maximize productivity and return-on-investment. Generally, this requires optimizing product mix, output, and equipment availability.

While operating in full automation mode (i.e., with no human intervention), these systems produce output with great speed and efficiency. However, there are functions that do not easily lend themselves to automation. One of these areas is the decision of when to run equipment or equipment process qualification monitors. Typically, in today's factories, people decide which, when, and how to run qualification monitors and then place the equipment in a qualification, or test, state manually. There are many different types of qualification monitors, such as foreign material, etch rate, etch stop, polish rate, dose, deposition, and calibration monitors. Because of factors, such as the number of monitors used, the number of monitor types, and the high level of process and logistic complexity, it is clear that automating process and tool qualifications can be highly difficult. If monitoring runs are not automated, tools sit idle waiting for monitors, which seriously impacts production throughput. Conversely, if the monitors are run on a strict schedule, this results in excessive qualification monitor usage and the loss of valuable equipment processing time, thereby increasing production costs and reducing equipment availability.

What is needed, therefore, is a way to automate process and tool qualifications that is based, in part, on various manufacturing events.

### BRIEF SUMMARY OF THE INVENTION

Embodiments of the invention include methods for automating process and equipment qualifications in a manufacturing environment. A method includes defining a triggering event for initiating a qualification of an equipment, process module, or process. The qualification is configured to identify whether the equipment, process module, or process is operating according to specified criteria. The method also includes qualifying a monitor for use in the qualification. Upon the occurrence of the triggering event, the method includes running qualified monitors through the qualification. Based upon the results of qualifying the monitor for use in the qualification or the results of the execution of the qualification, the method includes determining and implementing a disposition for the monitor.

Additional embodiments include systems for automating process and equipment qualifications in a manufacturing environment. A system includes a host system and a qualification automation application executing on the host system, the qualification automation application implementing a method. The method includes defining a triggering event for initiating a qualification of an equipment, process module, or process. The qualification is configured to identify whether the equipment, process module, or process is operating according to specified criteria. The method also includes qualifying a monitor for use in the qualification. Upon the occurrence of the triggering event, the method includes running qualified monitors through the qualification. Based upon the results of qualifying the monitor for use in the qualification or the results of the execution of the qualification, the method includes determining and implementing a disposition for the monitor.

Further embodiments include computer program products for automating process and equipment qualifications in a manufacturing environment. A computer program product includes instructions for causing computer to implement a method. The method includes defining a triggering event for initiating a qualification of an equipment, process module, or process. The qualification is configured to identify whether the equipment, process module, or process is operating according to specified criteria. The method also includes qualifying a monitor for use in the qualification. Upon the occurrence of the triggering event, the method includes running qualified monitors through the qualification. Based upon the results of qualifying the monitor for use in the qualification or the results of the execution of the qualification, the method includes determining and implementing a disposition for the monitor.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a portion of a system upon which qualification automation functions may be implemented in exemplary embodiments;

FIGS. 2A-2B is a flow diagram describing a process for implementing qualification automation functions in exemplary embodiments;

FIG. 3 is a kit table with sample data generated by the qualification automation functions in exemplary embodiments;

FIG. 4 is a user interface screen for implementing a routine qualification via the qualification automation functions in exemplary embodiments; and

FIG. 5 is a user interface screen for implementing a manual qualification via the qualification automation functions in exemplary embodiments.

The detailed description explains the preferred embodiments of the invention, together with advantages and features, by way of example with reference to the drawings.

### DETAILED DESCRIPTION OF THE INVENTION

Disclosed herein are methods, systems, and computer program products for automating process and equipment qualifications in a manufacturing environment. In a typical manufacturing facility, manufacturing processes and equipment are periodically monitored to ensure high quality output (e.g., to ensure that products meet customer specifications and/or government standards) and to safeguard personnel working in the facilities. Manufacturing equipment and newly installed processes may be subject to qualification when first introduced into the facility and, due to normal wear and tear or unexpected damage during use, may require ongoing qualifications over its lifetime. For example, in a semiconductor manufacturing environment, photomasks used in lithography tools may be qualified when first introduced into the manufacturing facility and may be monitored periodically to ensure they are qualified for continued use. As described herein, a qualification refers to the use of a monitor wafer to qualify a piece of equipment or an equipment process.

The automated process and equipment qualifications provide the ability to automate the qualifications of processes and tools in a production facility. The automation includes start-to-build (STB) processes, measurements, and disposition of product materials. A start-to-build process refers to a methodology used to introduce raw wafers to a route (e.g., to prepare the raw wafers for qualification). A route refers to a sequence of process steps including, e.g., build operations, pre-measurement operations, actual qualification operations (e.g., where the prepared wafer is used to qualify a piece of equipment or equipment process), post-measurement operations, and disposition operations. These operations are described further herein. Once the qualification system is implemented, it maintains the equipment in a qualified state. In the event of a qualification failure, the system may automatically notify maintenance for repair.

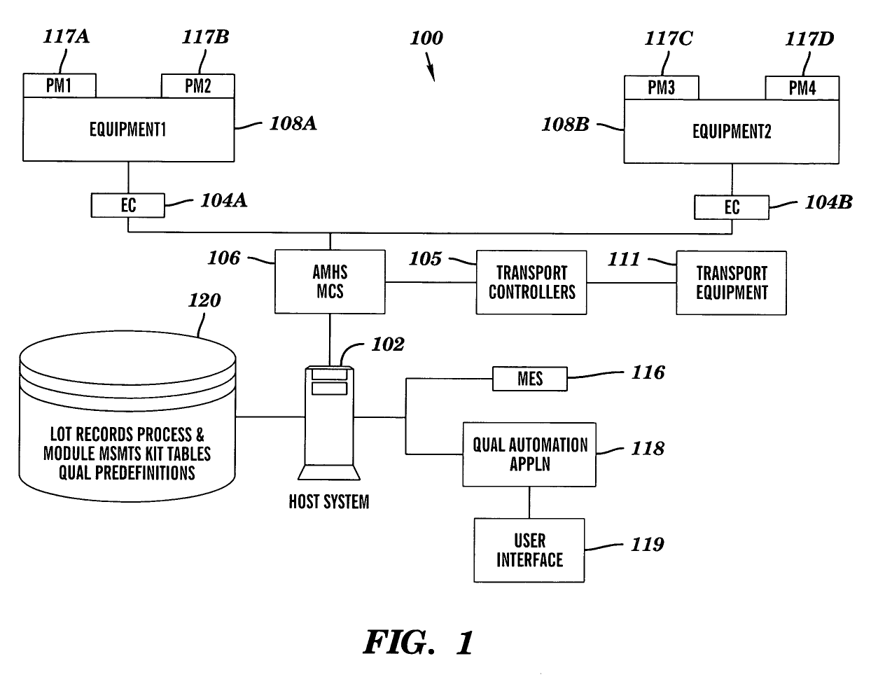

Turning now to FIG. 1, an exemplary system 100 for automating process and equipment qualifications will now be described. For purposes of illustration, the system 100 of FIG. 1 represents a fully automated semiconductor fabrication facility. However, it will be understood that the processes described herein may be employed in other environments as well, e.g., any automated facilities operating industrial equipment.

The system 100 of FIG. 1 includes a host system 102 in communication with an automated material handling system (AMHS) 106 via any suitable communications technologies (including wireline and wireless). Host system 102 may comprise a high-speed processor for handling the volume of production activities typically found in a manufacturing facility. For example, in an automated IC fabrication facility (Fab), such as a facility for processing 300 mm wafers, the host system 102 may execute an automated manufacturing execution system (MES) 116, such as IBM's® ITS SiView Standard MES.

Host system 102 may also execute other applications, such as a real time dispatcher (RTD) application. The RTD includes programmable logic that tells the MES which lots to process for every tool in the production area, based on, e.g., schedules, priorities, commit dates, etc. The RTD or dispatcher may be built in as part of the MES, may be a separate component of the MES 116, such as the SiView Schedule™, or it could be a third party application. In addition, the host system 102 may implement a messaging application for generating and transmitting notifications concerning qualifications to concerned entities as described further herein.

The automated process and equipment qualifications may be implemented by one or more applications executing on host system 102. These one or more applications are collectively referred to as qualification automation application 118. The qualification automation application 118 enables an authorized entity, e.g., production manager/team, to identify and designate qualification criteria and events for determining deployment of a qualification monitor. The qualification automation application 118 may include a user interface component 119 that enables one or more authorized users to define qualifications and input or select triggering events for use in automating the qualification processes with respect to the production area of FIG. 1. The qualification automation application 118 and user interface 119 include data fields for identifying qualification monitors, defining qualifications including triggering events for initiating the qualifications, routing qualification monitors based upon various measurements (e.g., rework, downgrade, reclaim), and assigning qualification monitor states based upon implementation of various qualification operations. In addition, the qualification automation application 118 includes timing controllers for tracking various manufacturing and qualification events as will be described further herein.

Also shown in the system of FIG. 1 is a storage device 120. The storage device 120 may be implemented by memory contained within host system 102, or may be a separate physical storage device that is logically addressable by the host system 102. The storage device 120 stores data such as manufacturing plans, lot records, process and module measurements, kit tables, qualification pre-definitions, and other information as desired by the manufacturing entity implementing the host system 102. This information is described further herein.

AMHS 106 manages the transport of materials (lots) within a production area. The lots may comprise 300 mm wafers. A material control system (MCS) application, such as Murata's Automated Control System by Murata Machinery, Ltd™, may also be implemented for receiving operations and scheduling information for materials to be processed on production equipment via, e.g., host system 102.

The AMHS 106 is in communication with production equipment 108A and 108B, which are located in an area of the facility referred to as a production area. In response to a triggering event, the AMHS 106 delivers selected qualification monitors to production equipment 108A and 108B via a carrier. The production equipment 108A and 108B take qualification monitors from the carrier through its loadports (not shown). The carrier is transported through the production area in accordance with a pre-determined route. The carrier may be implemented, e.g., as a front-opening unified pod (FOUP). The route, in turn, may be a logical construct of the MES 116, which stores the route information in memory (e.g., storage device 120). The triggering event will be described further herein.

Production equipment 108A and 108B further include equipment process modules (“process modules”) 117A-117B and 117C-117D, respectively, that perform operations on materials (e.g., production wafers and qualification monitors) in accordance with a manufacturing plan. Production equipment 108A and 108B may include computers and/or microprocessor-based controllers (equipment controllers or ECs 104A-104B, respectively), which control the internal operation of the equipment 108A-108B and most, if not all, exchanges of information with other elements of the facility (e.g., AMHS 106 and transport/stocker equipment 111). Production equipment 108A and 108B receive controller commands over suitable communication paths (e.g., wireline or wireless means), which in turn provide various responses. These communication paths may utilize the same or separate physical wires, coaxial cables, optical cables, radio frequency links, etc. While only a single production area is shown, it will be understood that multiple production areas may be managed by host system 102 in terms of implementing the qualification automation activities described herein. In addition, it will be understood that production equipment 108A and 108B may employ a single process module or multiple process modules (i.e., multi-chamber equipment) in order to realize the advantages of the exemplary embodiments. In exemplary embodiments, the production equipment 108A-108B are SEMI-compliant (i.e., conform to standards set forth by Semiconductor Equipment and Materials International (SEMI), an organization with established goals to further industry improvement by bringing industry persons together to solve common technical issues).

The FOUPs store materials (e.g., 300 mm production wafers and/or qualification monitors) that are awaiting processing and/or transport. Each of process modules 117A-117D performs one or more processes on materials in accordance with a manufacturing plan. Materials that are used in manufacturing may include substances, component parts, assemblies, and other items typically found in a manufacturing environment. For purposes of illustration, the materials are referred to as production wafers and qualification monitors. In an exemplary embodiment, qualification monitors refer to materials that are used to qualify or test the efficacy of at least one production equipment, equipment process module, and process performed on the materials.

These process materials (i.e., lots) may be assigned to various production areas. In an automated facility, these lots (e.g., production wafers and qualification monitors) are moved around (e.g., from equipment to equipment, from equipment to storage, from storage to equipment, etc.) in accordance with a specified manufacturing plan or route, via transport equipment 111. Transport equipment 111 may include mechanized ground vehicles such as an automated guided vehicle (AGV) or personal guided vehicle (PGV), or may include an overhead transport (OHT) device supported by a monorail that transfers WIP materials between equipment and/or production areas. The movement of transport equipment 111 is typically prompted via signals received from AMHS 106 via transport controllers 105. For example, the materials in FOUPs may be stored in a fixed buffer. The materials in a FOUP may be assigned to a job (e.g., next-in-line in processing) awaiting production equipment 108A with another FOUP following behind. When production equipment 108A becomes available, AMHS 106 signals transport equipment 111 via transport controllers 105 to pick up the FOUP from the fixed buffer and deliver it to an available loadport on production equipment 108A.

The manufacturing execution system 116 ensures that lots are processed in accordance with a manufacturing plan that specifies the nature of the processing to be performed, which tools are required, the sequence in which process steps are to be performed, and where a lot will be redirected after completion of each process step. The MES 116 maintains a production queue that tracks lots waiting for processing at a production machine or waiting for transport between production equipment/areas. In addition, a qualification queue is utilized for storing qualification monitors that are awaiting qualification on one or more production equipment 108A-108B. Some or all of this information may be stored in memory at the host system 102 in any suitable form desired by the manufacturing facility. For purposes of illustration, this information is stored in individual lots records in storage device 120 as shown in FIG. 1.

As indicated above, processes and equipment in a manufacturing facility often require qualification monitoring. The qualification automation application 118 includes a user interface 119 that enables an authorized entity (e.g., production team members) to establish criteria and triggering events that control how, when, and where a qualification will take place. The qualification automation application 118 may be a separate application in communication with the MES 116, or may be integrated with the MES 116.

As indicated above, qualifications may be defined and implemented for specified equipment (including stockers and carriers), equipment process module, process of the equipment or equipment process module, and/or a combination of the above. For each process module, there may be varying qualifications identified, such as process qualification, transfer qualification, carrier qualification, and inspection. In addition, there may be one or more qualifications defined for each equipment, equipment process module, process, and combination thereof. Qualification classifications include routine and manual. Routine qualifications may be implemented on an ongoing basis (e.g., periodic/scheduled) to ensure the equipment, process module, process, etc. is operating according to its originally qualified criteria. A manual qualification may be implemented “on demand.”

In addition to these classifications, there are also varying types of qualifications that may be run on the equipment of FIG. 1. For example, in a 300 mm fab facility, there may be one or more qualifications defined for a piece of equipment or a process module on a piece of equipment which measure various physical attributes or characteristics, such as particulate count, etch rate, etch selectivity, polish rate, dopant concentration, deposition (e.g., thickness, uniformity, and density), and calibration. Likewise, each qualification defined requires a specific type of qualification monitor. During qualification, physical measurements are taken for a qualification monitor based upon the type of qualification. The physical measurements (e.g., particulate count) are compared with performance characteristics (e.g., particulate count acceptability limit) defined for a piece of equipment or process module on the equipment.

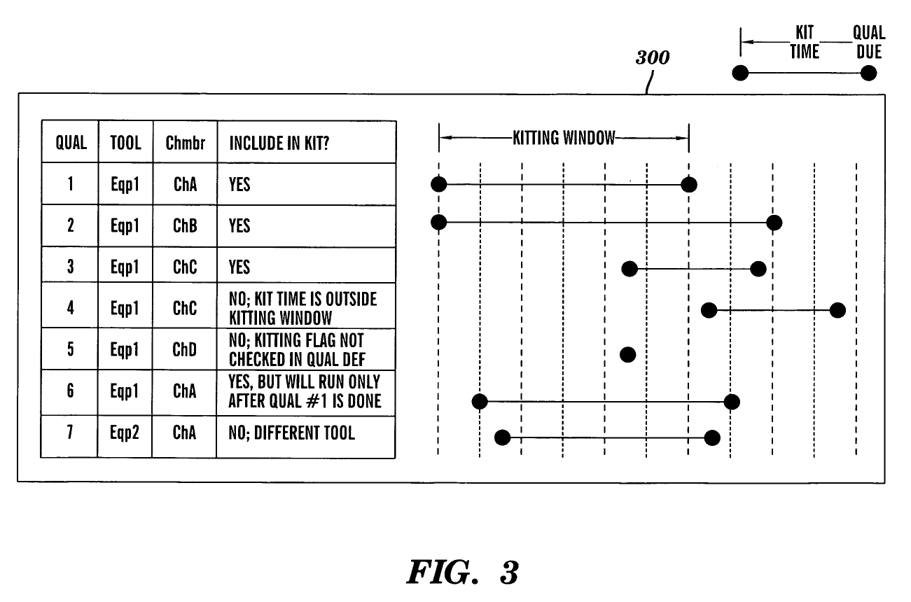

The qualification automation application 118 enables a user to select a particular classification of qualification (e.g., routine or manual), a particular type of qualification based upon the performance characteristics to be assessed (e.g., particulate count, etch rate, etch selectivity, polish rate, dopant concentration, deposition, such as thickness, uniformity, and density, calibration, etc.), a kitting table, and associated triggering events for initiating a qualification. An exemplary kitting table is shown in FIG. 3. The kitting table 300 enables the user to establish a time frame (kitting window) for special types of qualifications that require, e.g., different types of qualification monitors on a single production equipment (e.g., production equipment 108A), qualification monitors for different processes implemented on a single production equipment (e.g., process modules 117A-117B on production equipment 108A), or other instances where simultaneous qualifications are performed for a defined group of qualification monitors. The qualification automation application 118 may use the kitting table 300 to select appropriate qualification monitors to be gathered and transported for processing as described further herein.

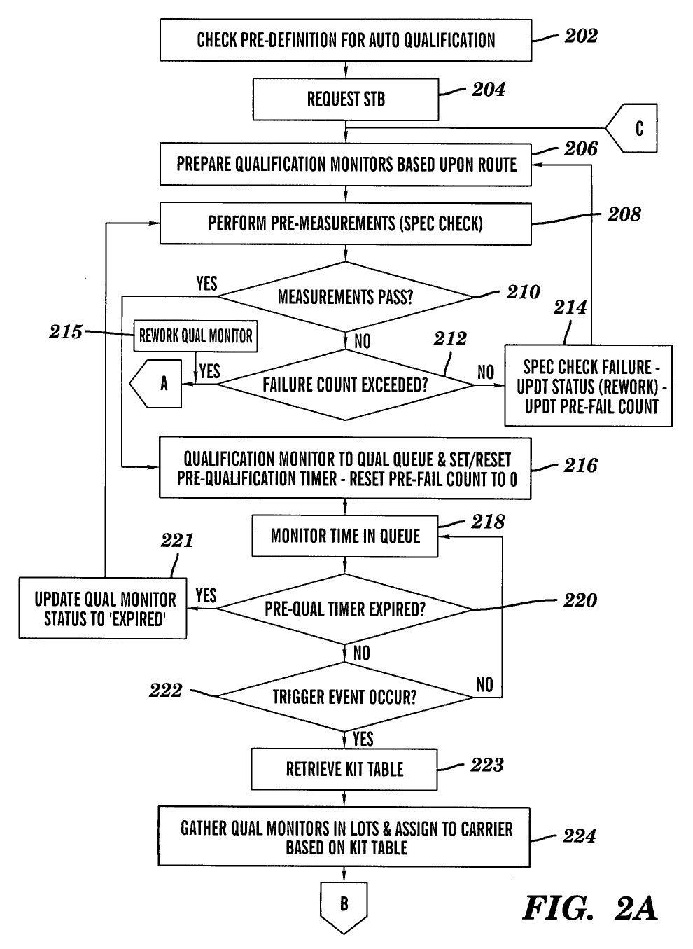

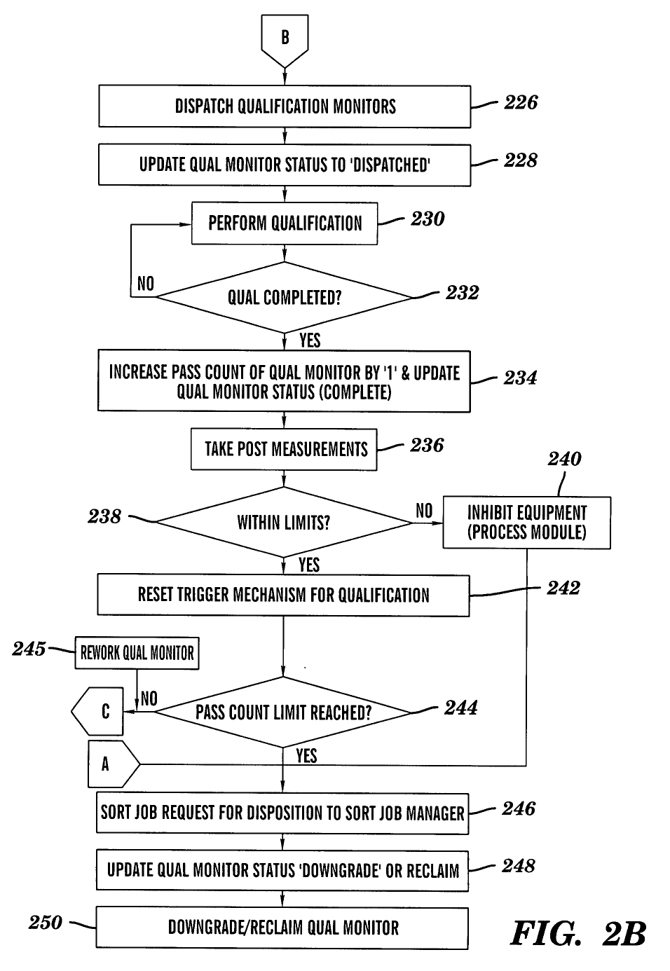

Turning now to FIGS. 2A-2B, a process for implementing the qualification automation functions will now be described in exemplary embodiments. The qualification automation application 118 may provide all of the functionality described in FIGS. 2A-2B or may interact with existing MES 116 components (e.g., RTD, wafer control monitor, materials manager, sort job manager, equipment monitor, kit watchdog, delivery watchdog, etc.) to implement the functionality of the qualification automation functions.

Raw wafers may be introduced into the fab in a ‘start’ bank. The start bank may be a logical construct used by MES 116 to identify materials (e.g., wafers) for entry into a route (e.g., a stocker tool). When the wafers are released through the STB process, they are placed in the MES 116 onto a route. As described above, a route is a sequence of operations defined for a product ID. The MES 116 moves the wafers along that route through operations in a queue in front of a qualification operation.

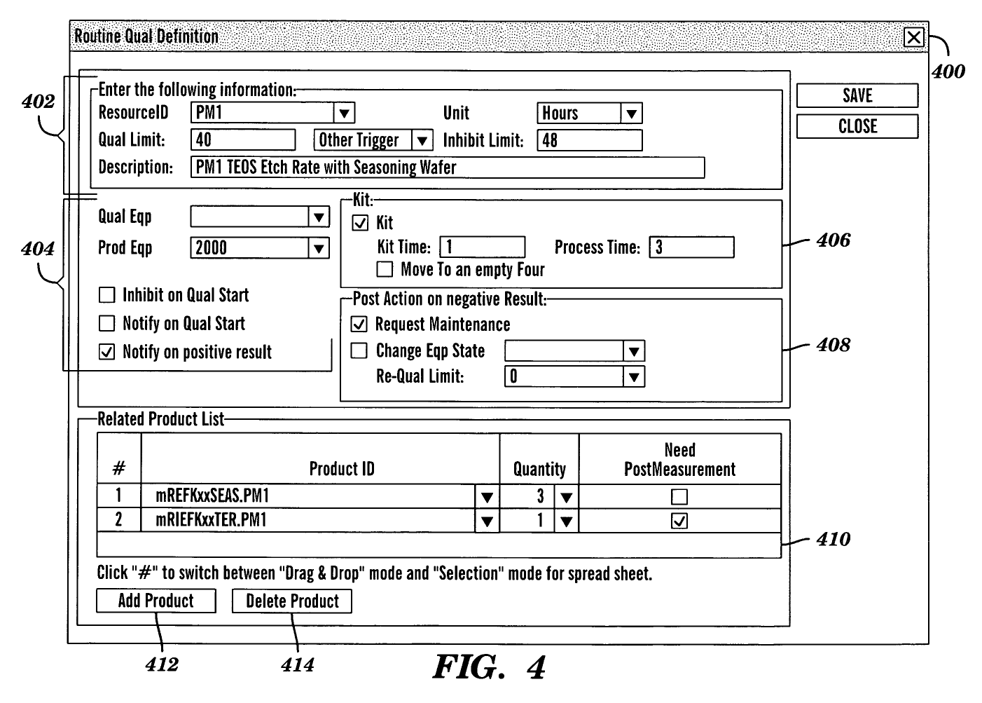

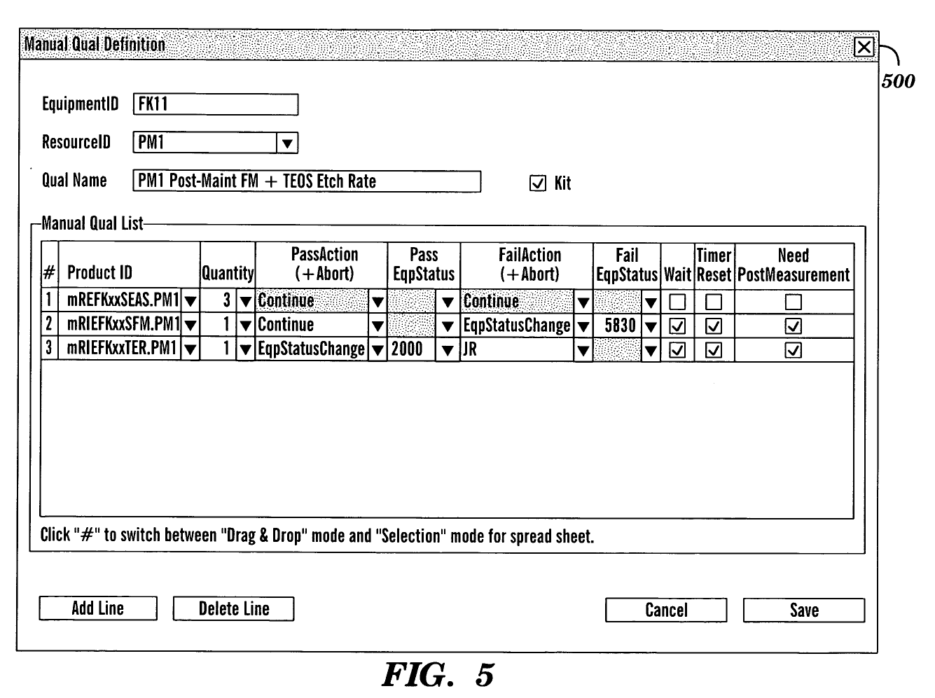

A pre-definition for auto-qualification is determined for identifying criteria and triggering events for initiating the qualification automation functions at step 202. As indicated above, the pre-definition may be provided by a designated individual via the qualification automation application 118 and user interface 119. An exemplary user interface screen for implementing routine qualifications is shown in FIG. 4. In addition, an exemplary user interface screen for implementing a manual qualification is shown FIG. 5.

Triggering events for initiating a qualification may be time based events (e.g., a redetermined time or at periodic times). Triggering events may also be based upon a wafer count or lot count, a number of process hours on particular equipment and/or process module, a status change, post equipment repair, planned maintenance, or a manual trigger.

A user of the qualification automation application 118 selects a class of qualification to be performed via the user interface 1119. The qualification automation application presents the user with the appropriate user interface screen depending upon the classification selection. For example, as shown in FIG. 4, a user interface 400 for initiating a routine qualification is shown. The user enters general qualification characteristics in sections 402 and 404 of the user interface screen 400. General characteristics include, e.g., ResourceID, Unit, Qual Limit, Other trigger, Inhibit Limit, Description, Qual Eqp, Prod Eqp, Inhibit on Qual Start, Notify on Qual Start, and Notify on positive result. ResourceID refers to a process module (e.g., PMl 117A) for qualification. If the qualification is for the overall equipment (e.g., equipment 108A), this field may be left blank. Unit refers to a qualification counter.

Qual Limit refers to a count (e.g., time, number) when a qualification will be requested for dispatch (e.g., a number of hours since the last timer reset). The Qual Limit may be used as a triggering event for automatically initiating a qualification. This field specifies a time-based triggering event. However, it will be understood that other types of triggering events may be selected for initiating a triggering event, e.g., number of materials (e.g., wafers) processed for a particular equipment and/or process module via the Other trigger field. Upon the occurrence of a triggering event, a qualification is initiated. Inhibit Limit specifies when production equipment (e.g., production equipment 108A, 108B) or a process module (e.g., process modules 117A-117D) will become inhibited, such as when a qualification has not completed. Description refers to a unique description for each routine qualification on an equipment/process module.

Various equipment states represent what actions a piece of equipment (e.g., production equipment 108A, 108B) is capable of doing (e.g., processing, waiting for product (e.g., qualification monitors), down for repair, running a product, waiting for qualification, etc.). Qual Eqp refers to a state change for an equipment/process module at the start of a qualification. Prod Eqp refers to a state change for corresponding equipment/process module based upon positive post measurements (i.e., measurements taken after the qualification). When Inhibit on Qual Start is checked by the user, an inhibit status for an equipment/process module is initiated upon qualification dispatch to a qualification operation. When Notify on Qual Start is checked by the user, a notification is transmitted to a designated entity (e.g., production team members) upon starting a qualification. When Notify on Positive is checked by the user, a notification is transmitted to a designated entity (e.g., production team members) when positive post measurements result from a qualification.

In addition to defining general qualification characteristics, the user enters product identification information in section 410 of the user interface screen 400. By selecting the ‘Add Product’ button 412, the user may add a monitor for the qualification. The ‘Delete Product’ button 414 is used to remove a monitor from qualification. The user enters (or selects) product IDs for all monitors needed for a qualification. A drop down feature displays all defined qualification product IDs. Multiple monitors are combined into one carrier and dispatched to equipment (e.g., production equipment 108A, 108B) via one control job. The user selects the monitor quantity for each selected Product ID. In addition, the user checks the ‘Need PostMeasurement’ box if post-measurements are required for the qualification. Depending upon the type of qualification selected, post measurements may not be required. Monitors that need no post measurements are treated as a “pass” for the qualification. The qualification automation application 118 tracks the number of times a qualification monitor has gone through qualification. This count is referred to herein as a Pass CT. The Pass CT is a lot characteristic. A pass CT limit is a product ID characteristic that refers to a limit on the number of times a qualification monitor may be used for qualifications before being downgraded. Qualification monitors may be run in the order inputted by the user (e.g., where the user may designate/modify the order via the “#” field).

The user may define kitting operations for a qualification via section 406 of the user interface screen 400. When ‘Kit’ is checked, monitors selected for this qualification will be checked for concurrent or parallel qualifications. Kit Time enables the user to define a kitting window for concurrent qualifications on selected production equipment (e.g., equipment 108A). The kit time is set to the number of hours before this qualification is due and monitors are combined, for transport by a common carrier, for any qualifications scheduled within this window of time. Process Time enables the user to define a window for optimally selecting a qualification wafer in order to minimize the wait time before physically executing the qualification on the equipment (e.g., equipment 108B). The window may be defined as the qualification process time plus post measurement time and transport time. The monitors are separated into a different carrier if other lots in the carrier will be needed for qualifications within this window. If Move To an empty Foup is checked, qualification monitors are separated into empty carriers prior to dispatch to a qualification operation. The user enters qualification fail options in section 408 of the user interface screen 400. If Request Maintenance is checked, a maintenance request will be sent to a designated entity based upon any negative post measurement results. In addition, if Change Eqp State is checked, a state of production equipment/process module under qualification is changed based upon any negative post measurement results. Re-Qual Limit refers to a minimum number of re-qualifications to be performed before taking actions based on a negative post measurement result. Re-qualifications may be dispatched automatically until a Re-Qual Limit is reached.

As shown in FIG. 5, a user interface screen 500 for defining a manual qualification is provided. A manual qualification is implemented “on demand” with respect to production equipment (e.g., 108A-108B) and/or process modules (e.g., 117A-117D). Many of the data fields described above with respect to the user interface screen 400 of FIG. 4 are the same as those provided in user interface screen 500. To this extent, the descriptions thereof will be omitted. The user enters an equipment identification in field 502, a resource ID (process module ID) in field 504 (if applicable), and a qualification name in field 506. For each product ID, the user may check the Wait box to indicate if the qualification should make a pass/fail decision based on this monitor and all previous monitors. Those monitors occurring after the Wait flag are not processed through the qualification step until post measurements are completed. The Timer Reset button is checked to reset the corresponding routine qualification timer based upon positive post measurement results. The PassAction (+Abort) and FailAction (+Abort) fields are used to specify whether additions monitors should be run after a Wait flag.

Returning now to FIG. 2, the qualification automation application 118 enables the implementation of an automated start-to-build (STB) process. In response to a STB request, designated materials (e.g., wafers) are taken out of the start bank, defined as either production wafers or qualification monitors via production wafer identifiers and qualification monitor identifiers assigned thereto (e.g., via ProductID in section 410 of FIG. 4), and placing the defined wafers/monitors on its appropriate routes based upon pre-definitions and qualification definitions at step 204. The qualification automation application 118 monitors the number of wafers on a route, as well as the number of usable wafers for each product ID. Whenever the usable number of wafers for a product ID drops below a target quantity (e.g., a minimum number of usable wafers to maintain at a given time for that product ID), the STB process replenishes the wafers to achieve the target quantity. The target quantity is a product ID characteristic (e.g., as illustrated in section 410 of FIG. 4). At the disposition phase of the qualification process, one of two actions may be taken for a rejected qualification monitor: reclaim or downgrade. A qualification monitor selected for reclaim may be scrapped. A qualification monitor selected for downgrade may be put in bank, and the automated STB function is configured to pull specific downgraded wafers for reuse (e.g., based upon product ID for wafers needed to achieve a target quantity).

At step 206 the qualification monitors are prepared as defined for their route, e.g., via user interface 400 or user interface 500. For example, a pre-definition may specify that a qualification designed to measure contamination instruct the qualification monitor go through a cleaning process. A qualification designed to measure removal of film may specify that the qualification monitor go through a process in which a film is deposited thereon.

In order to determine what effect an equipment, process module, or process has on a qualification monitor, pre-measurements are taken for the qualification monitors at step 208. The types of measurements taken are based upon the type of qualification assigned to the monitor. The measurements are compared against pre-defined specifications for the monitors. For example, a specification may provide an acceptability limit for the number of particles added to a surface of the qualification monitor. In addition, a specification may provide an acceptability limit for an etch rate or thickness of a film deposited on a qualification monitor. The results of the pre-measurements determine whether a qualification monitor is acceptable to proceed with a defined qualification (also referred to herein as ‘qualifying a monitor for use in a qualification).

At step 210, it is determined whether the pre-measurements are within acceptable limits (via the acceptability criteria provided in the specifications). If not, the qualification automation application 118 updates a pre-measurement failure count (also referred to as “pre-fail count”) for the qualification monitor and then determines whether the qualification monitor has exceeded a pre-defined limit of failed pre-measurements at step 212. As indicated above, these criteria may be defined by a user of the qualification automation application 118 via user interface 119. The pre-measurement fail limit is a product ID characteristic. For example, the limit of consecutive failed pre-measurements for a qualification monitor may be set to two. If this count has been exceeded, then the qualification monitor is selected for re-work at step 215, and the process continues to step 246 of FIG. 2B where the lot is selected for downgrade or reclaim. Otherwise, if the pre-measurement failure count has not been exceeded, then the qualification automation application 118 updates the status of the qualification monitor (e.g., as “rework”) at step 214, the pre-fail count for the monitor is updated to reflect the failed pre-measurements, the qualification monitor is reworked, and the process returns to step 206 (i.e., the qualification monitor is returned to the qualification monitor preparation process).

Returning to step 210, if the pre-measurements are acceptable, the pre-fail count for the monitor is reset to zero, a pre-qualification timer is set by the qualification automation application 118, and the qualification monitor waits in a qualification queue at step 216. The time transpiring between the pre-measurement stage and the current time (e.g., where the qualification monitor waits in the queue for a triggering event to occur) is measured at step 218. Expiration of a pre-qualification time (e.g., due to shelf life, queue time, and queue time limit) may be established, e.g., where the condition of qualification monitor is known to deteriorate over time rendering it unacceptable for qualification. At step 220, it is determined whether the pre-qualification timer has expired. If so, at step 221, a status of the qualification monitor is updated to “expired” and the process returns to step 208 where pre-measurements are again taken. If the pre-qualification timer has not expired, the qualification monitor continues to wait in the queue. At step 222, it is determined whether a triggering event has occurred. As indicated above, triggering events may be defined based upon various events, such as time elapsed since previous qualification, number of materials/lots processed, etc. If a triggering event has not occurred, the process returns to step 218 whereby the pre-qualification timer continues to measure the time the qualification monitor is in the qualification queue.

If a triggering event has occurred at step 222, the qualification automation application 118 retrieves a kit table associated with the qualification at step 223. As indicated above, kitting operations may be defined for a qualification (e.g., via user interface screens 400 and 500), which result in a kitting table. The qualification automation application 118 senses kit time and qualification timer time (e.g., via an equipment monitor). The kit time and qualification timer time may be used to generate the kit table and corresponding rules for determining whether to authorize a qualification event. The qualification automation application 118 utilizes the kit time and qualification timer activity to determine events. As indicated above, multiple qualifications may be defined for a single production equipment via the kit table. Upon the occurrence of a triggering event, the qualification automation application 118 looks for any other qualification monitors that are due for that production equipment (e.g., 108A, 108B) within the timeframe established in the kitting window of the kit table. At step 224, qualification monitors designated for the qualification are gathered and assigned to a carrier based upon the kitting table and pre-definitions and the process continues in FIG. 2B.

At step 226, the qualification monitors (e.g., lot) are then dispatched to a process module (e.g., PMs 117A-117D), equipment (108A-108B), process, etc., based upon the kit table. At step 228, a status of the qualification monitor is updated to “DISPATCHED” (e.g., after a control job is successfully created) and the qualification is performed at step 230. Alternatively, if a dispatch flag is OFF in the MES 116 (e.g., material manager), the RTD may be selected for initiating the dispatch.

At step 232, it is determined whether the qualification is complete. If not, the qualification continues at step 230. Otherwise, the pass count for the qualification monitor is increased by “1” and a status of the qualification monitor is updated to reflect completion of the lot qualification at step 234. The pass count identifies the number of times a qualification monitor has gone through a qualification process.

At step 236, post measurements are taken for the qualification monitor to assess the results of the qualification performed at step 230. The post-measurements are compared to the pre-measurements to determine what effect, if any, the qualification process (via the equipment, process module, process, etc.) had on the qualification monitor. Various types of measurements may be taken based upon the type of qualification. For example, a contamination qualification may involve comparing a difference between pre- and post-measurements (i.e., particle count) and using the delta to determine whether the qualification yields positive/acceptable results or negative/unacceptable results. The post-measurements are analyzed using, e.g., statistical process control (SPC) methods. It is determined whether the post measurements are positive (e.g., within acceptable limits) or negative (outside of acceptable limits) at step 238. If negative, this means the equipment, process module, process, etc. under qualification failed the qualification process and an inhibit signal is transmitted to the equipment (e.g., the affected equipment, process module, process) at step 240 and the process continues to step 246. The results of the post measurements, either positive or negative, may be captured by the qualification automation application 118 and a notification generated and transmitted to a designated entity (e.g., a production team/member) as configured via the user interface 119.

If the post measurements yield positive or acceptable results, the qualification automation application 118 resets the triggering elements designated for the respective equipment, process module, process, etc., (e.g., qualification timer, materials/lot count limits, etc.) based upon the pre-definition at step 242. At step 244, it is determined whether the pass count limit established for the qualification monitor has been exceeded. The pass count limit ensures that a qualification monitor is not continuously used in qualification procedures due to, e.g., degradation.

If the pass count limit has not been reached at step 244, the qualification monitor is reworked at step 245 and returned to the preparation phase of step 206 for re-use in the qualifications. However, if the pass count limit has been reached, or if the post measurements are not within acceptable limits (from step 238), or alternatively, if a pre-measurement failure count has been exceeded (from step 212), a sort job request for disposition (e.g., de-kit) is generated and transmitted to the MES 116 (e.g., a sort job manager (SJM)) component at step 246.

At step 248, the qualification monitor status is updated to “DOWNGRADE” or “RECLAIM” in accordance with the pre-definition. The downgraded or reclaimed product is automatically moved to a bank-in process for handling at step 250. The downgraded or reclaim product is moved to the last bank-in operation and to the end bank. The disposition of the failed qualification monitors may include downgrading the monitors (e.g., for internal recycling for use as other monitor types) or reclaiming the monitors (e.g., scrap). The determination whether to downgrade or reclaim the failed monitors is based upon the product ID (e.g., the target quantity needed as described above with respect to the STB process) and the results of qualifying the monitor for use in the qualification and/or the results of the post measurements.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for automating process and equipment qualifications in a manufacturing environment, comprising:
defining a triggering event for initiating a qualification of at least one of an equipment, process module, and process, the qualification configured to identify whether the equipment, process module, or process is operating according to specified criteria;
qualifying a monitor for use in the qualification;
upon an occurrence of the triggering event, running qualified monitors through the qualification; and
based upon results of at least one of the qualifying a monitor for use in the qualification and execution of the qualification, determining and implementing a disposition for the monitor.

2. The method of claim 1, wherein the triggering event includes at least one of:
a time-based event;
a monitor count;
an equipment state change; and
manual initiation of the qualification.

3. The method of claim 1, wherein qualifying the monitor for use in the qualification includes:
preparing the monitor based upon a type of qualification; and
measuring characteristics of the monitor resulting from preparation; and
comparing measured characteristics against specifications associated with the type of qualification; wherein:
if the measured characteristics are within pre-defined acceptable limits, approving the monitor for the qualification;
if the measured characteristics are not within the pre-defined acceptable limits, determining a pre-measurement failure count for the monitor, the pre-measurement failure count indicating a number of consecutive times the monitor was prepared, characteristics thereof measured, and resulting measurements fell below the pre-defined acceptable limits;
if the pre-measurement failure count exceeds a specified limit, downgrading or reclaiming the monitor; and
if the pre-measurement failure count does not meet a specified limit, preparing the monitor for another qualification.

4. The method of claim 1, further comprising:
establishing criteria for the qualification, the criteria used in measuring physical characteristics of the monitor after the qualification, the criteria including at least one of:
particulate count;
etch rate;
etch selectivity;
polish rate;
dopant concentration;
calibration; and
deposition.

5. The method of claim 1, wherein running the qualified monitors through the qualification include:
dispatching the qualified monitor on a pre-defined route, the route specifying equipment, processes, and operations to be performed on the qualified monitor;
measuring post qualification performance characteristics of the qualified monitor;
comparing the post qualification performance characteristics of the qualified monitor to pre-measurements taken for the monitor before execution of the qualification; and
determining a pass or fail status of the qualified monitor as a result of the comparing.

6. The method of claim 1, further comprising defining kitting operations for the qualification including:
a kit time for defining a kitting window for concurrent or parallel qualifications on the at least one of an equipment, process module, and process, the kit time set to the number of hours before the qualification is due; and
process time for defining a kitting window for parallel qualifications to occur, the process time defined as qualification process time plus post measurement time and transport time;
wherein the method further comprises:
in response to the occurrence of a triggering event, selecting qualified monitors to be gathered into a single carrier and transported for processing based upon the kitting window.

7. The method of claim 1, further comprising:
tracking a number of usable monitors in a production facility; and
replenishing the production facility with additional monitors when the number of usable monitors falls below a defined threshold.

8. The method of claim 7, wherein the additional monitors are replenished, in part, using downgraded monitors resulting from the disposition.

9. A system for automating process and equipment qualifications in a manufacturing environment, comprising:
a host system; and
a qualification automation application executing on the host system, the qualification automation application implementing a method, comprising:
defining a triggering event for initiating a qualification of at least one of an equipment, process module, and process, the qualification configured to identify whether the equipment, process module, or process is operating according to specified criteria;
qualifying a monitor for use in the qualification;
upon an occurrence of the triggering event, running qualified monitors through the qualification; and
based upon results of at least one of the qualifying a monitor for use in the qualification and execution of the qualification, determining and implementing a disposition for the monitor.

10. The system of claim 9, wherein the triggering event includes at least one of:
a time-based event;
a monitor count;
an equipment state change; and
manual initiation of the qualification.

11. The system of claim 9, wherein qualifying the monitor for use in the qualification includes:
preparing the monitor based upon a type of qualification; and
measuring characteristics of the monitor resulting from preparation; and
comparing measured characteristics against specifications associated with the type of qualification; wherein:
if the measured characteristics are within pre-defined acceptable limits, approving the monitor for the qualification;
if the measured characteristics are not within the pre-defined acceptable limits, determining a pre-measurement failure count for the monitor, the pre-measurement failure count indicating a number of consecutive times the monitor was prepared, characteristics thereof measured, and resulting measurements fell below the pre-defined acceptable limits;
if the pre-measurement failure count exceeds a specified limit, downgrading or reclaiming the monitor; and
if the pre-measurement failure count does not meet a specified limit, preparing the monitor for another qualification.

12. The system of claim 9, wherein the qualification automation application further performs:
establishing criteria for the qualification, the criteria used in measuring physical characteristics of the monitor after the qualification, the criteria including at least one of:
particulate count;
etch rate;
etch selectivity;
polish rate;
dopant concentration;
calibration; and
deposition.

13. The system of claim 9, wherein running the qualified monitors through the qualification includes:
dispatching the qualified monitor on a pre-defined route, the route specifying equipment, processes, and operations to be performed on the qualified monitor;
measuring post qualification performance characteristics of the qualified monitor;
comparing the post qualification performance characteristics of the qualified monitor to pre-measurements taken for the monitor before execution of the qualification; and
determining a pass or fail status of the qualified monitor as a result of the comparing.

14. The system of claim 9, wherein the qualification automation application further performs defining kitting operations for the qualification including:
a kit time for defining a kitting window for concurrent or parallel qualifications on the at least one of an equipment, process module, and process, the kit time set to the number of hours before the qualification is due; and
process time for defining a kitting window for parallel qualifications to occur, the process time defined as qualification process time plus post measurement time and transport time;
wherein the method further comprises:
in response to the occurrence of a triggering event, selecting qualified monitors to be gathered into a single carrier and transported for processing based upon the kitting window.

15. The system of claim 9, wherein the qualification automation application further performs:
tracking a number of usable monitors in a production facility; and
replenishing the production facility with additional monitors when the number of usable monitors falls below a defined threshold;
wherein the additional monitors are replenished, in part, using downgraded monitors resulting from the disposition.

16. A computer program product for automating process and equipment qualifications in a manufacturing environment, the computer program product including instructions for causing a computer to implement a method, comprising:
defining a triggering event for initiating a qualification of at least one of an equipment, process module, and process, the qualification configured to identify whether the equipment, process module, or process is operating according to specified criteria;
qualifying a monitor for use in the qualification;
upon an occurrence of the triggering event, running qualified monitors through the qualification; and
based upon results of at least one of the qualifying a monitor for use in the qualification and execution of the qualification, determining and implementing a disposition for the monitor.

17. The computer program product of claim 16, wherein the triggering event includes at least one of:
a time-based event;
a monitor count;
an equipment state change; and
manual initiation of the qualification.

18. The computer program product of claim 16, wherein qualifying the monitor for use in the qualification includes:
preparing the monitor based upon a type of qualification; and
measuring characteristics of the monitor resulting from preparation; and
comparing measured characteristics against specifications associated with the type of qualification; wherein:
if the measured characteristics are within pre-defined acceptable limits, approving the monitor for the qualification;
if the measured characteristics are not within the pre-defined acceptable limits, determining a pre-measurement failure count for the monitor, the pre-measurement failure count indicating a number of consecutive times the monitor was prepared, characteristics thereof measured, and resulting measurements fell below the pre-defined acceptable limits;
if the pre-measurement failure count exceeds a specified limit, downgrading or reclaiming the monitor; and
if the pre-measurement failure count does not meet a specified limit, preparing the monitor for another qualification.

19. The computer program product of claim 16, further comprising instructions for implementing:
establishing criteria for the qualification, the criteria used in measuring physical characteristics of the monitor after the qualification, the criteria including at least one of:
particulate count;
etch rate;
etch selectivity;
polish rate;
dopant concentration;
calibration; and
deposition.

20. The computer program product of claim 16, wherein running the qualified monitors through the qualification include:
dispatching the qualified monitor on a pre-defined route, the route specifying equipment, processes, and operations to be performed on the qualified monitor;
measuring post qualification performance characteristics of the qualified monitor;
comparing the post qualification performance characteristics of the qualified monitor to pre-measurements taken for the monitor before execution of the qualification; and
determining a pass or fail status of the qualified monitor as a result of the comparing.
